(19) United States
(12) Patent Application Publication
(10) Pub. No.: US 2014/0317546 A1
(43) Pub. Date: Oct. 23, 2014

(54) Logic Visualization Machine

(71) Applicants: Jesse Martin Jacobson, Atlanta, GA (US); Dov Jacobson, Berkeley Lake, GA (US)

(72) Inventors: Jesse Martin Jacobson, Atlanta, GA (US); Dov Jacobson, Berkeley Lake, GA (US)

(73) Assignee: BIG FUN DEVELOPMENT CORPORATION, Berkely Lake, GA (US)

(21) Appl. No.: 13/867,940

(22) Filed: Apr. 22, 2013

(51) Int. Cl. G06F 3/0481

(52) U.S. Cl. CPC G06F 3/04817
USPC 715/771

(57) ABSTRACT

A logic visualization machine that uses dynamic physical analog pictograms to illustrate logical argument structures. With this approach, an analysis of alternative hypotheses is presented in a side-by-side comparison in which each hypothesis is visualized by a similar physical analog pictogram. Elements of evidence are illustrated as physical analog components in the pictograms and ascribed to each pictogram on a consistent basis allowing dynamic adjustment of the pictogram to visually represent the comparative weighting of the evidence in the competing hypotheses. The invention further includes mechanism for incorporating and visualizing logical complexities into the pictograms, including logical operations (e.g., and, or and xor groups) and nested statements. Logic trees and the entry points for individual pieces of evidence can be readily revealed. Quantitative factors including the valence assigned to evidence and validity assessments are made explicit and exposed visually within the pictogram construct.

### REFERENCE TO RELATED APPLICATION

This application claims priority to U.S. Provisional Patent Application Ser. No. 61/635,863 entitled “Method and Device for Argument Manipulation” filed Apr. 20, 2012, which is incorporated by reference.

### TECHNICAL FIELD

The present invention relates to logic mapping systems and, more particularly, to a logic visualization machine using dynamic physical analog pictograms to create, illustrate and analyze logic arguments including alternatives of competing hypotheses.

### BACKGROUND

Logical arguments are fundamental to the human experience. While countless hours have been spent generating, explaining, supporting, rebutting and judging logical arguments, it can often be difficult to make the internal structure and support for and against an argument explicit. A number of approaches have been developed for exposing argument structures including logic maps, argument maps and charts describing analyses of competing hypotheses. However, these approaches are difficult to use and understand because the presentation formats lack intuitive connotation. It can also be difficult to ascertain the significance of individual statements and pieces of evidence to an ultimate conclusion.

Conventional approaches for diagramming logical arguments also lack the ability to quickly and easily alter weighting factors and validity assignments to multiple hypotheses. Many systems also fail to disambiguate between significance and validity. Cumbersome user interfaces and presentation formats limit the ability of logic mapping systems to keep up with human interaction in real time. The introduction of even modest complexity, such as logical operations and nested concepts, can make the logic maps difficult to visualize. At the same time, the need for effective and efficient mechanisms to reveal, evaluate and modify argument structures continues to be critical. Important decisions, ranging from committing countries to war to selecting after school activities for our children, and countless others, hang in the balance every day. There is, therefore, a continuing need for techniques for improving logical argument evaluation and, more particularly, for more effective and efficient ways to create, visualize, analyze, and continually modify logical argument structures and supporting evidence.

### SUMMARY

The needs described above are met by a logic visualization machine that uses dynamic physical analog pictograms to illustrate logical argument structures. While this approach can be used to analyze a single hypothesis in isolation, it is even more powerful when comparing alternative hypotheses. With this approach, an analysis of alternative hypotheses is presented in a side-by-side comparison in which each hypothesis is visualized by a similar physical analog pictogram. Elements of evidence are illustrated as components (dynamic icons) having physical significance within the physical analog pictograms and ascribed to each pictogram on a consistent basis allowing dynamic creation and adjustment of the pictogram to visually represent the comparative weighting of the evidence in the competing hypotheses.

The invention further includes mechanism for incorporating and visualizing logical complexities into the pictograms, including logical operations (e.g., AND, OR and XOR groups) and nested statements. Logic trees and the entry points for individual pieces of source evidence can be readily revealed. Quantitative factors including the perceived valence of evidence within a particular argument or the validity assessment of that evidence are made explicit and exposed visually within the pictogram construct. The logic visualization machine provides for dynamic pictogram generation and display allowing users and collaborative groups of users to create, evaluate and continually modify logical arguments in real time. The ability to present multiple pictograms in side-by-side relation allows at-a-glance evaluation of alternative hypotheses. Structuring the pictograms as physical analogs provides intuitive connotation not achieved by prior logic mapping systems.

In an illustrative embodiment, the dynamic physical analog pictogram is a tube of water (test tube) in which a hypothesis is depicted as a minimally buoyant block that floats or sinks to indicate its degree of computed validity. The initial buoyance is sufficient to float the evidence block half way and statements (evidence) are added to help support (float) or detract from (sink) the computed validity of the hypothesis. Statements are visually presented (visualized) as a dynamic physical analog components (dynamic icons) having physical significance within the physical analog pictogram. For example, supporting evidence may be visualized as bubbles under the hypothesis block tending to keep the hypothesis block afloat, while detracting evidence may be visualized as ballast weights on top of the hypothesis block tending to sink the hypothesis block. The size of the dynamic icon corresponding to one piece of evidence represents the magnitude of the valence of that evidence in that hypothesis, the position (and possibly another attribute such as color) represents the direction (positive or negative influence), and line weight or opacity represents the validity of that evidence. This allows similarly depicted pieces of detracting evidence to be piled on top of the hypothesis block, while similarly depicted pieces of supporting evidence are piled beneath the hypothesis block to add buoyance. The logical significance of the evidence is therefore readily apparent from the physical significance of the displayed attributes of the dynamic icons within the physical analog pictogram, including the number of pieces of evidence (number of dynamic icons) involved, the relative valence (size), direction of influence (position), and validity (line weight or opacity) of the dynamic icons.

Several competing pictograms can be placed side-by-side to show a comparison of competing hypotheses through the visual comparison of the side-by-side physical analog pictograms. Validity valuations are assigned for original source evidence at their points of entry into the logic tree and carried forward into nodes representing complex evidence that combine multiple pieces of evidence into computed validity valuations, which are carried forward to subsequent nodes. Complex evidence indicia may be displayed in or near the dynamic icons to indicate evidentiary complexity, such as logical operations and nested evidentiary constructs. Selection of any node (complex evidence structure) exposes a detailed physical analog pictogram for the node allowing review and adjustment of the evidentiary components represented by the node.

Various types of folding are used to collapse the logic tree into nodes depicted as physical analog pictograms for high-level viewing, while selection items allow for expansion of nodes to expose the deeper structure of the logic tree. Nesting and logical operations can be illustrated through folding, in which a single dynamic icon visually displayed as a single piece of evidence represents a number of pieces of evidence or evidentiary substructures. In the test tube embodiment, for example, each piece of evidence in the test tube (node) can itself be a test tube (node) taking several pieces of evidence into account. In effect, each node represents a weighted sum of evidentiary components, in which each evidentiary component can itself represent a weighted sum of evidentiary components, in a logic tree structure. Folding allows the branches to be folded and unfolded through selection items on the user interface.

There are several types of complex evidence structures represented in the logic visualization machine, including nested structures, tag groups, filter groups, logical operation groups, and statistical operation groups, which can be combined as desired. In a nested evidentiary structure, a single piece of evidence represents a weighted sum of evidentiary components in which each component in the weighted sum can, in turn, represent a weighted sum of evidentiary components, and so on. In a logical operation, a single piece of evidence represents a group of evidentiary components, such as a logical group to which a logical operation applies (e.g., AND group, OR group, XOR group, etc.), or an aggregate group to which a common attribute applies (e.g., tag group, filter group, etc.)

In a folded evidentiary structure, original evidence can be entered at any level of the logic tree where it is assigned a validity value. This validity value can then be carried forward (along with an assigned valence) as an evidentiary component in one or more subsequent nodes where it is combined with other pieces of evidence and reduced to a computed validity for the subsequent node, which can likewise be carried forward through a series nested evidentiary substructures. Each piece of evidence is assigned a base validity value when originally entered, while complex validity values are computed and carried forward into upstream evidence structures. At each node of the logic tree, and for each competing hypothesis represented at each node, the carried statement can be assigned a unique valence for its inclusion at that point in the logic tree. In other words, a nested piece of evidence carried forward into to a current position in a logic tree has a carried validity (computed at previous level in the tree) and an assigned valence for its inclusion at the current position in a logic tree.

The logic visualization machine may also include selection items for folding complex evidence for convenient, high-level viewing and unfolding to reveal the underlying structure. User interfaces are also provided for exposing the original entry points of pieces of evidence and for illustrating the sensitivity of the hypotheses to individual pieces of evidence.

While the test tube is provided as the illustrated example for the physical analog pictogram, the concept is to be understood generally and other pictograms may be used. Typical examples include a balance scale, seesaw, basket floated by balloons, hovering helicopter, weighted spring, celestial orbiting body, and so forth. Similarly, relative motion rather than position could be used to denote a local comparison, where the physical analog pictograms may be spinning clocks, racing vehicles, jumping characters, etc. The logic visualization machine may also be configured to switch among different pictograms for the same argument in response to a user selection.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

The numerous advantages of the invention may be better understood with reference to the accompanying figures in which:

FIG. 1 is a block diagram illustrating a general purpose computer configured with software allowing it to operate as a logic visualization machine.

FIG. 2 is a conceptual illustration of user interface display for the logic visualization machine.

FIG. 3 shows an alteration of the user interface display indicating a first type of evidentiary alteration.

FIG. 4 shows an alteration of the user interface display indicating a second type of evidentiary alteration.

FIG. 5 shows an alteration of the user interface display indicating a third type of evidentiary alteration.

FIG. 6 shows an alteration of the user interface display indicating a fourth type of evidentiary alteration.

FIG. 7 shows an alteration of the user interface display indicating a fifth type of evidentiary alteration.

FIGS. 8A-C are conceptual illustrations of user interface techniques for visualizing nested evidence structures.

FIGS. 9A-D are conceptual illustrations of user interface techniques for visualizing logical operations evidence structures.

FIGS. 10A-C are conceptual illustrations of user interface techniques for exposing evidence entry points and sensitivities in nested evidence structures.

FIGS. 11A-C are conceptual illustrations of user interface techniques for displaying validity sensitivity analyses for an evidentiary component.

FIG. 12 is a conceptual illustration of a user interface technique for comparing validity sensitivity analyses for multiple evidentiary components.

FIG. 13 is a conceptual illustration of a user interface technique for defining a Bayesian inference with the logic visualization machine.

### DETAILED DESCRIPTION OF ILLUSTRATIVE EMBODIMENTS

The invention may be embodied in a logic visualization machine that utilizes dynamic physical analog pictograms to illustrate logical argument structures. The logic visualization machine may be implemented through any suitable computing device, such as a dedicated computing device or as software configured to operate on a general purpose computer. For example, the invention may be embodied as a software application program for a personal computer, an app for a mobile computing device, a server application supporting multiple client machines in a network environment, or any other suitable computing system. As such, the invention may be embodied in an operational hardware, software stored in a non-transient computer storage medium, or in the underlying methodology.

The logic visualization machine is a sophisticated computer application for creating, manipulating and visualizing argument logic tree structures including alternatives of competing hypotheses. In the development of a logic tree, evidence is a statement employed in the argument to support or deny a hypothesis. Validity is a measure of the validity of a statement, which can be expressed in a number of ways, such as Boolean, probability, fuzzy property or other metric. Valence refers to the degree to which evidence supports or denies an associated hypothesis. Valence is therefore an assessment of the argumentative impact or relevance or rhetorical leverage of the statement to the hypothesis. For each piece of evidence, valence is therefore assigned on a per-hypothesis basis.

A validity valuation, on the other hand, applies to a piece of evidence globally throughout the logic tree. Whereas a different valence value can be assigned to the same piece of evidence for different hypotheses and at multiple different points (nodes and competing hypotheses) in the tree, a validity valuation is only assigned once for a particular piece of evidence. The term direction is typically used to refer to the sign of a valence indicating whether the evidence supports (positive valence) or detracts (negative valence) from the associated hypothesis. Magnitude refers to the absolute value of a valence. Folding refers to using a single collective symbol as a shorthand reference to a group of symbols. In the test tube pictogram, a test tube representing a combination of multiple pieces of evidence is folded into a dynamic icon representing a single piece of evidence in a higher-level test tube pictogram. Each test tube pictogram therefore serves as a node visually and computationally combining a number of pieces of evidence. Each node is ultimately reduced to a computed validity value for the node, which can be carried forward and computationally considered in a subsequent node. While the computed validity value for the node is carried forward, the valence ascribed to that node as piece of evidence incorporated into a subsequent node is assigned individually for each subsequent node that incorporates the carried node as an evidentiary component.

In a logical argument, a statement generally refers to an assertion representing a piece of evidence or a complex construct of multiple pieces of evidence (node). An argument is a logical arrangement of statements that use reason to determine validity. The relative strength of related arguments pertaining to a common conclusion can be compared by assigning (or computing) each argument a normalized measure of validity. An axiom typically refers to a statement that is taken as true and may be presented without argument.

A hypothesis is a statement whose validity is evaluated by argument. The decision or judgment considered with a logical argument can be evaluated through an analysis of competing hypotheses in which each hypothesis has an assigned (or computed) measure of validity. An analysis of competing hypotheses (ACH) is used to determine the most likely of mutually exclusive hypotheses; often different options for answers to the same questions. Therefore, the entire ACH process can in some cases be generalized to include some kind of mutual truth between hypotheses. For example, there may be two hypotheses that are assuredly (or maybe only likely) either both true or both false. Other examples or related hypotheses result from complex webs of causality given by predicate logic (e.g., If (A and B) then (C xor D)).

The logic visualization machine uses a side-by-side display of similar dynamic physical analog pictograms to illustrate an analysis of competing hypotheses. The purpose of the machine is to improve human reasoning and decision making by clearly exposing logical arguments and the underlying support to aid in the development, discussion, and refinement of the argument. Clear logic can improve comprehension, critique and manipulation by individuals and collaborative teams. Users of the logic visualization machine may include those who propose an argument, those to whom it is proposed, and third parties who may serve in various roles, such as experts, consultants, juries, referees, mentors or students.

The theory of operation behind the logic visualization machine is to reduce intellectual reasoning underlying an argument from natural language statements, which typically include implicit and subjective correlations and weighting factors applied to various pieces of supporting and detracting evidence, to computations in which those correlations and weighting factors are made explicit and exposed for review and manipulation. The results of the computations are then presented through an unambiguous graphic display in which dynamic physical analog pictograms visualize the structure and components of the argument. Logical rules and common illustrative techniques govern the behavior of the symbolic elements. This provides an analytic foundation requiring evidence to be disclosed, implicit weighting factors to be made explicit, subjective assessments to be shown objectively, and complex evidentiary structures to be broken down and expressed in computable in computable logical constructs. The logic visualization machine thus enforces rigorous thinking, provides a common basis for expressing and evaluating evidence, improves communication and evaluation by those constructing or considering the argument.

A further advantage is afforded the user by embedding secondary analytic tools within the core logic mapping system. These context-sensitive tools may operate orthogonally or diagonally to the argument and serve to improve the many estimates and judgments that are attendant to the composition of the logic map. The present invention also applies computational power to argument resolution. Once the relationship among its terms is modeled by the user, a full argument or any proposition within it can be evaluated by one or more algorithmic methods.

The logic visualization machine may be embodied in any suitable computing device that employs any of a large and growing number of computational equipment that supply visual display, instruction driven processors, memory and human input sensors. Real time remote collaboration, a valuable but optional feature of this invention also requires communication hardware. It is futile to attempt to exhaustively enumerate the equipment classes that now supply such elements, and impossible to anticipate those which will do so in the near future. A brief sample would include traditional computers, laptops, tablets, smartphones, televisions, video game consoles, handheld games and calculators, embedded systems in dashboards, kiosks, appliances and tables, as well as networked systems where these various elements can be distributed across multiple pieces of equipment and several classes of equipment. This invention is the method by which such equipment and its general operating system and software can be employed as the tool described herein. This invention is the aggregate of instructions that result in the behavior described in this description.

The logic visualization machine includes one or more tools to display one or more dynamic physical analog pictograms and enable their manipulation and computational resolution. This dynamic physical analog pictogram is a unique specialized feature of the invention providing the means by which a logical argument may be presented, manipulated or resolved.

In general, an argument is a logical system of statements. It is the relationship between these statements that models the argument. An argument consists of a hypothesis and evidence. The hypothesis is a statement whose validity is in question. The evidence is one or more statements that each support or deny the hypothesis. Every statement in the evidence can itself be a hypothesis. The argument recursively presents evidence at deeper and deeper levels until it arrives at axioms.

Each statement asserts a fact. This assertion can be true or false. In many cases, a statement has a measure of validity. This measure of validity can, depending on context, represent probability (eg: in statistical analysis), certainty (eg: in investigational analysis), intermediacy or degree (eg: in fuzzy logic). In this description, as elsewhere, this validity metric is known as validity. Validity can generally assume any of an infinite number of values ranging inclusively from false to true. The purpose of this tool is to examine the validity of statements.

The relationship of evidence to a hypothesis is referred to as valence. Valence has a direction: evidence can either support or deny its hypothesis. Valence also has a magnitude, which measures the degree of this support or denial. Valence is determined by the creator of the logic map at the point where a particular piece of evidence is entered into the argument. Typically the assignment of valence is a human judgment. Once assigned, the valence for a particular piece of evidence can be carried into complex evidentiary structures, such as logical operation and nested. Unlike validity, valence cannot be readily calculated from the graph itself. External processes, such as the statistical analysis of observations can potentially yield useful results.

Other structured analytic techniques such as diagnostic reasoning can be employed to improve the user's assignment of validity. The logic visualization machine may incorporate these analytic techniques in tools that are directly available to the user at the point of valence assignment. Similarly, the machine may include available tools for improved estimation of the validity of axioms. Such optional tools may employ well-known structured analytic techniques for validation, which may be inherent in the system or available as selectable options. For example, the machine may allow an axiom originally presumed to be true to be questioned by transforming the axiom into a hypothesis. Supporting and detracting evidence can then be added, allowing it to be evaluated as rigorously as any other argument in the logic map.

Compound or complex evidence involves logical combinations of multiple statements that serve as evidence for a hypothesis. The valence values assigned or computed for independent statements can be aggregated through logical operations (e.g., logical and, or and xor groups). Statements that are joined by logical operators share a common valence. The determination of their aggregate validity is a function of the conjunctive operator. Evidence grouped by AND has no validity unless all statements are valid (e.g., a group statement of Car Starts might include Has Key, Has Gas, Battery Charged.) In more continuous measurements of validity, an OR might choose to implement well-known analogous functionality based on context: the greatest valence in some fuzzy logic systems or the well known methods for determining the probability of any event from a set of events occurring in statistical analysis. Evidence joined by the OR conjunction has validity if any statement is valid. Note that unlike independent statements, additional valid statements in OR group add no weight to the argument. This is appropriate to highly correlated statements. (e.g., an OR group called “Alex paid for dinner” might include “Dinner charge on Alex's credit card statement and “Alex's credit card in the restaurant receipts”. More evidence adds no valence.

It is often useful that a single statement appears in multiple places within an argument. It may serve as supporting evidence for one hypothesis while denying another. In such cases, each instance represents the same statement. The validity of the statement is identical across all instances. The valence of each instance is independent, and is determined based on the context in which it appears. In Bayesian logic, a statement is often instantiated in both positive and negative form. In this case, the system maintains complementary validity for the two forms. When investigation of an axiom promotes it to a hypothesis, this occurs in all instances, as does the reverse. Folding an instance of a statement folds only that local instance.

Logical arguments are reduced to computational analyses expressing validity as a normalized value (typically as a decimal value between zero and one, although any normalization convention may be used as a matter of design choice) and valence to a positive or negative normalized value. Once valence and validity values are reduced to normalized values, computed validity values can be readily ascertained for evidentiary constructs involving multiple pieces of supporting and detracting evidence. Specifically, the computed validity of a node incorporating several components is the weighted sum of the valences of constituent components, where the component validity values (whether assigned or computed) are the weighting factors. This allows assigned and computed valence values for individual and compound items of evidence to be computationally carried forward through nested evidence structures. The system thus invites mathematic resolution of a complex logic structure to an ultimate validity value, which may conceptually include an unlimited number of statements (nodes), any number of which may include compound and nested structures.

In most logical tree structures, validity propagates upward from the axiomatic and assigned validity of the terminal nodes (leaves) to the ultimate hypotheses where the valence of each evident statement is weighted by its validity and all evidence is aggregated to assign validity to the hypothesis. Different techniques for weighting and aggregation provide different models of argument construction. These methods include simple arithmetic calculation, Bayesian probability and fuzzy logic. Though these approaches may provide different results, the present invention may be readily adapted to accommodate different mathematic techniques, for example as a subject of user selection. The preferred approach provides a selection of computational paradigms, which allows the user communities to select and compare different paradigms for analyzing specific problems on an as needed basis. In addition to the bottom-up calculation described above, the logic visualization machine also allows Bayesian inference computations that start with the observed results of hypotheses and from these derive the validity of the initial axioms.

For visualization purposes, each statement is preferably represented by a distinct visible symbol, which is itself a dynamic physical analog pictogram. For example, evidence may be visualized as bubbles and ballast weights in a test tube pictogram, balloons and ballast weights in a floating balloon pictogram, weights on a balance scale pictogram, and so forth. The argument logic is represented by the arrangement of these symbols. These symbols demonstrate the logical function, the validity and valence of each statement. As one example, an axiom may be illustrated by the visual analog of a triangle. A hypothesis is a similar triangle with an unfilled triangle joined at their bases. Upward-pointing triangles are positive, and downward triangles are a negation. In some contexts, this negation indicated that the fact is inverted. In others, it distinguishes disconfirmation from confirmation. The validity of a statement is indicated by its visual salience. This salience may be achieved by the symbol's color, saturation, brightness, fill pattern, opacity, line style, line thickness and/or by the boldness of its font.

The valence of evidence is also indicated visually. The direction of the valence can be shown by the symbol's color, hue, orientation, shape and/or its position relative to the shape. In a scale embodiment, for example, evidence is visualized as suspended from the left of the hypothesis for denial and from the right for support. The magnitude of the valence can be shown by the size of the symbol. Lines connect hypotheses to supporting and denying evidence and indicate the conjunctive operators in evidence sets. For the sake of visual clarity, multiple statements can be folded into a single symbol. These folded symbols include logical operator evidence sets and the postulate, with which an entire argument can be reduced to a single symbol and treated much like an axiom. Such symbol folding is always reversible and never has any computational significance.

The preferred embodiment of this invention is engineered using well understood techniques to permit multiple users in differing locations to simultaneously manipulate the same argument in real time. The argument is rendered independently on each user's screen so that the collaborators see each other's work and can reason together. Each user sees the same logic map, but display-specific state (e.g., folding or pictographic representation) may be different on each collaborator's screen.

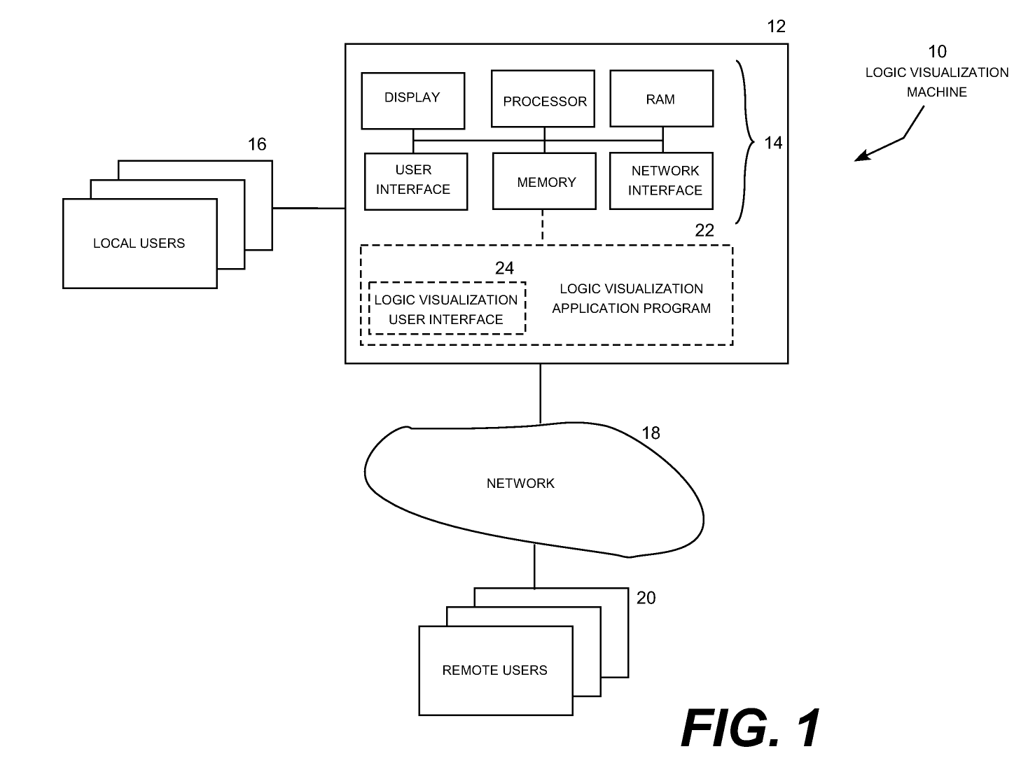

Turning now to the figures, FIG. 1 is a block diagram illustrating a general purpose computer 12 configured with software allowing it to operate as a logic visualization machine 10. The computer 12 includes the usual elements of a computing system 14 including a display (screen, speaker, etc.), processor, random access memory, user interface tools (keyboard, mouse, etc.), memory, system bus, network interface and so forth. In this particular embodiment, a logic visualization application program 22 including a logic visualization user interface 24 allows the general purpose computer to operate as the logic visualization machine 10. The logic visualization user interface 24 supports user interaction though the screen, keyboard, mouse, voice recognition and any other user interface tools supported by the computer system 12. In general, a number of local users 16 can use the machine, while a network 18 provides access to a number of remote users 20. As the logic visualization machine 10 is designed to facilitate logic argumentation, a primary mode of use will be collaboration among multiple users viewing a common argument model and sharing control in an administratively authorized manner.

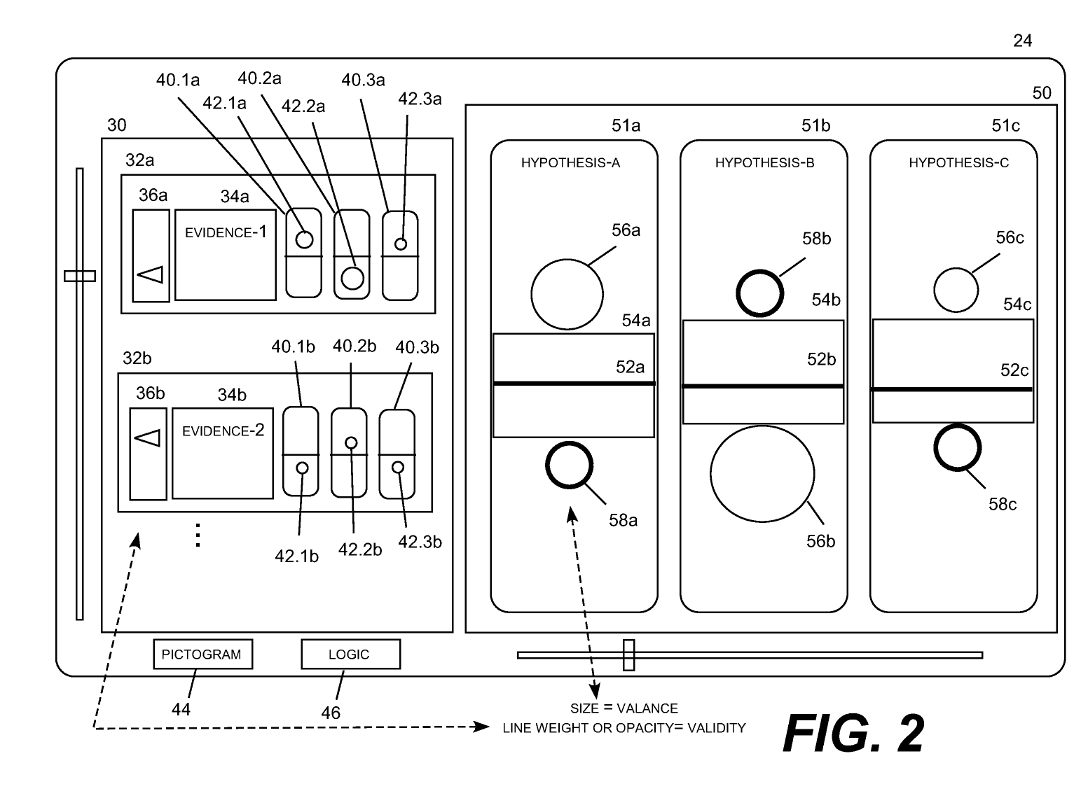

FIG. 2 is a conceptual illustration of the top level user interface (UI) display 24 for the logic visualization machine. The major components of the UI are an evidence panel 30 and a hypotheses panel 50. The evidence panel 30 includes a series of evidence bars (represented by two evidence bars 32a-b in this figure) in which each evidence bar pertains to a piece of evidence or combination of evidence (node) incorporated into the hypotheses panel 50. Conceptually, the number of pieces of evidence is not limited and the evidence panel 30 may serve as a scroll box allowing the user to view a selected number of evidence bars while perusing a larger selection of evidence entries.

The hypotheses panel 50 includes a series of physical analog pictograms (represented by three pictograms 51a-c in this figure) visually illustrating a comparison of alternative hypotheses for a particular logical problem under consideration. Conceptually, the number of physical analog pictograms is not limited and the hypothesis panel 50 may serve as a scroll box allowing the user to view a selected number of pictograms while perusing a larger selection of competing hypotheses. Using the pictogram 51a as an example, the physical analog is a test tube containing a central water line 52a, in which a hypotheses block 54a conceptually floats. The hypotheses block initially floats half way (water line in the center of the evidence block) and then varies with evidence applied to the pictogram. Detracting evidence is visualized as a ballast or weight 56a located on top of the hypotheses block 54a tending to sink the hypothesis, while supporting evidence is visualized as a bubble 58a located below the hypotheses block 54a, tending to float the hypothesis.

In the evidence panel 30, each piece of evidence (node) is represented by an evidence bar, which can be assigned to one or more of the competing hypotheses shown in the hypotheses panel 50. In the example shown in FIG. 2, the piece of evidence represented by the evidence bar 32a is assigned to each of the competing hypotheses represented by the pictograms 51a-c, as represented by the weight 56a in the pictogram 51a, the bubble 56b in the pictogram 51b, and the weight 56c in the pictogram 51c. This piece of evidence may be assigned different valence values in each hypothesis, which is visually represented by the differing sizes of the weights 56a-c in the pictograms 51a-c. The evidence may also be assigned a different direction (supporting or detracting) in each hypothesis, which is visually represented by the position of the dynamic icon (ballast or bubble) above or below the evidence block.

Similarly, the piece of evidence (node) represented by the evidence bar 32b is also assigned to each of the competing hypotheses represented by the pictograms 51a-c, as represented by the bubble 58a in the pictogram 51a, the weight 58b in the pictogram 51b, and the bubble 58c in the pictogram 51c. In this case, however, this piece of evidence is assigned the same valence value in each hypothesis, which is visually represented by the same sizes of the bubbles 58a-c in the pictograms 51a-c. The pieces of evidence do not need to be assigned to all of the available pictograms, but may be included or omitted, assigned a valence, and assigned a direction (supporting or detracting), for each hypothesis individually. In other words, valence is a hypothesis-specific attribute, whereas validity is a common attribute that applies equally to all instances of a piece of evidence. Although pictorial conventions are a matter of design choice, in this embodiment valence visually depicted as the relative size of the dynamic icon representing the evidence in the pictogram, whereas validity is visually depicted as the relative opacity (shown in FIG. 2 as line weight for illustrative convenience). Each pictogram 51a-c therefore shows the relative computed validity of its associated hypotheses, which is computed as the weighted sum of the items of evidence ascribed to it, where each piece of evidence has a valence value, a validity value, and a position above or below the hypothesis block in the pictogram indicating the direction of its influence. The end result of the logical computation is reflected in the computed validity for each hypothesis, which is visualized as the relative position of the evidence block 54a-c with respect to its water line 52a-c (i.e., the extent to which the hypothesis is floating or sinking).

Taking the top evidence bar 32a as an example, the bar includes an evidence block 34a, which includes the name assigned to this particular piece of evidence and may include a complex evidence indicator if appropriate. The evidence block 34a can be highlighted (typically by hovering cursor over the block) to reveal more information, such as a description of the evidence, metrics associated with the evidence, tags applied to the evidence. The evidence can also be enabled for selecting (typically by mouse clicking when highlighted) to edit the description or hyperlink to the evidence itself or a related link. The evidence bar 32a may actually represent a node and double clicking on the evidence block 34a, for example, may operate to make this node the current node with its constituents unfolded into the full panel display 24 for that node.

The evidence block 34a also includes a validity slider 36a that is used to display and in some cases to also assign the validity value ascribed to this particular piece of evidence. For an original piece of evidence entered at this point in the argument tree, the slider 36a is in an active mode allowing the user to move the slider control up or down to change the slider value assigned to the evidence. For a complex piece of evidence (e.g., a node) the validity value is computed at a lower level of the argument tree and carried forward to the present level, in which case the slider control is inactive (typically grayed out) at the present level. The validity value, whether assigned or carried, is visually indicated both in the slider control 36a and in the corresponding depiction of the evidence in the pictograms 51a-c through the opacity (represented by line weight in the figure) of the corresponding dynamic icon 58a.

The evidence block 34a also includes three valence indicators which have the appearance of small test tubes 40.1a, 40.2a and 40.3a containing valence icons 42.1a, 42.2a and 40.3a. Each valence icon connotes the direction and magnitude of the valence of this piece of evidence assigned to a corresponding pictogram. In particular, the test tube 40.1a contains a valence icon 42.1a connoting the direction (detracting, on top of the evidence block applying a downward force in the pictogram) and relative magnitude (moderate) of the corresponding pictogram element 56a in the hypothesis pictogram 51a. Similarly, the test tube 40.2a contains a valence icon 42.2a connoting the direction (supporting, below the evidence block applying an upward force in the pictogram) and relative magnitude (high) of the corresponding pictogram element 56b in the hypothesis pictogram 51b. Likewise, the test tube 40.3a contains a valence icon 42.3a connoting the direction (detracting, on top of the evidence block applying a downward force in the pictogram) and relative magnitude (low) of the corresponding pictogram element 56c in the hypothesis pictogram 51c.

The same convention applies to the evidence block 34b, which also includes three valence indicators having the appearance of small test tubes 40.1b, 40.2b and 40.3b containing valence icons 42.1b, 42.2b and 40.3b. Each valence icon connotes the direction and magnitude of the valence of this piece of evidence assigned to a corresponding pictogram. In particular, the test tube 40.1b contains a valence icon 42.1b connoting the direction (supporting, below the evidence block applying an upward force in the pictogram) and relative magnitude (low) of the corresponding pictogram element 58a in the hypothesis pictogram 51a. Similarly, the test tube 40.2b contains a valence icon 42.2b connoting the direction (detracting, on top of the evidence block applying a downward force in the pictogram) and relative magnitude (low) of the corresponding pictogram element 58b in the hypothesis pictogram 51b. Likewise, the test tube 40.3b contains a valence icon 42.3b connoting the direction (supporting, below the evidence block applying an upward force in the pictogram) and relative magnitude (low) of the corresponding pictogram element 58c in the hypothesis pictogram 51c.

The general operation of the user interface allows the user to (1) add and delete evidence (nodes) at various levels of the logic tree, (2) change the validity value assigned to each piece of evidence at its point of entry, (3) assign evidence (nodes) to hypotheses individually, (4) change the direction of influence (shown as supporting for evidence positioned below the hypothesis block and detracting for evidence positioned above the hypothesis block) on a per-hypothesis basis, change the magnitude of the valence on a per-hypothesis basis (shown as the size of the dynamic icon representing the evidence), change the validity value assigned to piece of evidence at the point of its original introduction into the logic tree.

Individual statements (nodes) may be assigned to hypotheses multiple times within a logic tree, including assignment to multiple hypotheses and assignment at more than one place in a nested logic structure for an individual hypothesis. While valence and direction of influence may be assigned on a per-hypothesis basis, the validity value assigned to a piece of evidence applies to all instances of the evidence in the logic tree. The user interface also allows the user to create complex evidence structures (nodes representing nested evidence structures and logical operation groups), reveal the points of entry of pieces of evidence, and view sensitivity analyses for the validity valued assigned to each piece of evidence. The user can also fold and unfold the logic tree to reveal complex evidence structures.

The logic visualization machine therefore provides the advantage of exposing the logic tree within the visual construct of the dynamic physical analog pictograms, which are placed side-by-side for a comparison of competing hypotheses. The physical analog pictograms convey an enormous amount of comparative logical considerations in an inherently intuitive manner that gives the user a “feel” for the data through the pictographic representation. The user can also create, modify, reveal evidentiary relationships, and analyze sensitivities to individual pieces of data in real time. The overall result is to expose complex logical arguments in an immediately intuitive manner allowing the user (or collaboration of users) to vary input data and view the impact those changes have on the ultimate conclusions, the sensitivity of the ultimate conclusions to valence and validity assignments, in real time. The physical analog pictographic representation of the logic tree in a foldable structure incorporating complex evidentiary structures, with all of the evidentiary weighting factors available for manipulation in real time, provided a tremendous improvement over prior logic diagraming techniques.

The test tube analogy shown in FIG. 2 is merely illustrative and the user interface may include a “pictogram” selection item 44 allowing the user to select the dynamic physical analog pictogram used for a given data set (e.g., test tube, scales, seesaw, floating balloon) as a matter of user selection, for example through a pop-up list menu. This is a straightforward conversion because each pictogram merely provides a different physical analog for illustrating the same data set. In addition, the user interface may also include a “logic” selection item 46 allowing the user to select and alter the logical analysis techniques for complex evidence (e.g., Boolean, Bayesian probability, fuzzy property or other metric) as a matter of user selection, for example through a pop-up menu. This is also a straightforward conversion because this selection merely defines the logical or statistical technique used to evaluate complex evidentiary structures.

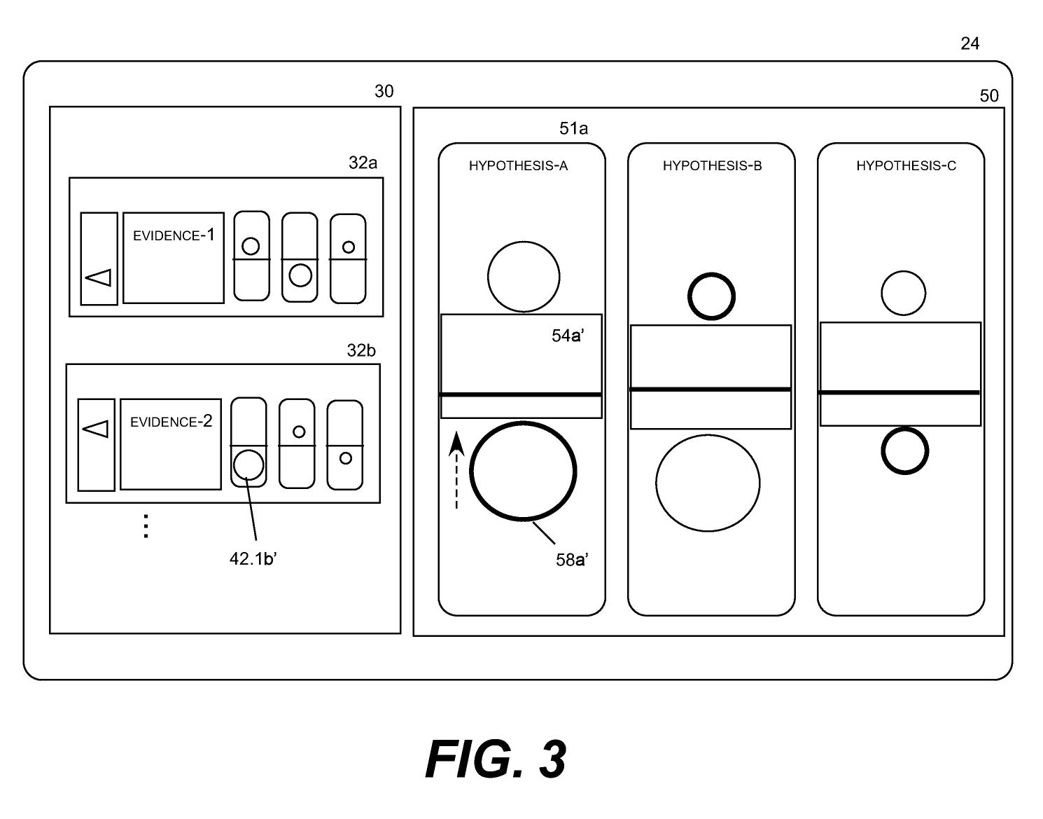

Continuing with the test tube physical analogy as the illustrative pictogram, FIG. 3 shows an increase in the valence of a supporting statement as a first type of logical alteration that may be applied trough the user interface display 24. In this example the valence of the statement represented by the dynamic icon 58a shown in FIG. 2 is increased to the size represented by the dynamic icon 58a′ shown in FIG. 3. As this is a valence adjustment, it can be applied to an individual hypothesis, in this example hypothesis-A represented by the dynamic pictogram 51a. The increase in valence is displayed both in the dynamic pictogram 51a and in the valence icon 42.1b associated with the evidence block for the altered piece of evidence 32b. For example, the user interface typically allows the user to enter this type of valence change with a point-click-drag-release mouse command applied to the dynamic icon 58a. Alternatively, the user may double click on the dynamic icon 58a to enter the desired valence numerically or with another suitable control item. The user may also drag-and-drop the evidence bar 32b onto any pictogram 51a-c to an instance of the evidence to a hypothesis with the drop location on the pictogram indicating whether the direction is supporting or detracting. The statement represented by the dynamic icon 58a, which is depicted as a bubble under the evidence block 54a, which represents supporting evidence pushing the evidence block 54a upward (helping the hypothesis-A to float). Therefore, increasing the valence of the this item, as represented by the increase in size from the dynamic icon 58a shown in FIG. 2 to the dynamic icon 58a′ shown in FIG. 3 causes the evidence block to move upward from the position of the evidence block 54a shown in FIG. 2 to the position of the evidence block 54a′ shown in FIG. 3.

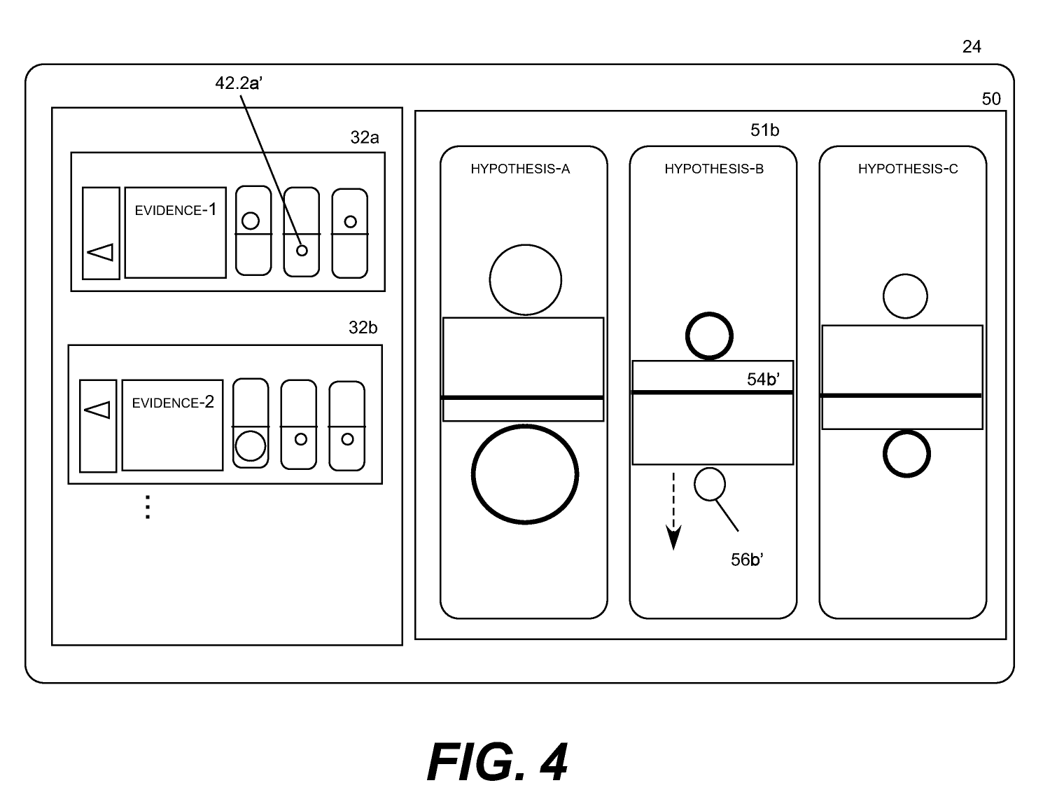

FIG. 4 shows a decrease in the valence of a supporting statement as a second type of logical alteration that may be applied to the logical argument represented by the user interface display 24. In this example, the valence of the statement represented by the dynamic icon 56b shown in FIG. 2 is decreased to the size represented by the dynamic icon 56b′ shown in FIG. 4. As this is a valence adjustment, it can be applied to an individual hypothesis, in this example hypothesis-B represented by the dynamic pictogram 51b. The decrease in valence is displayed both in the dynamic pictogram 51b and in the valence icon 42.2a associated with the evidence block for the altered piece of evidence 32a. The statement represented by the dynamic icon 56b, which is depicted as a bubble under the evidence block 54b, represents supporting evidence pushing the evidence block 54a upward (helping to float the hypothesis-B). Therefore, decreasing the valence of the this item, as represented by the decrease in size from the dynamic icon 56b shown in FIG. 2 to the dynamic icon 56b′ shown in FIG. 3, causes the evidence block to move downward from the position of the evidence block 54b shown in FIG. 2 to the position of the evidence block 54b′ shown in FIG. 4. It will therefore be appreciated that increasing the valence of supporting evidence and decreasing the valence of detracting evidence would have the similar effect of increasing the computed validity (visualized as buoyancy) of a hypothesis. Similarly, decreasing the valence of supporting evidence and increasing the valence of detracting evidence would likewise have the similar effect of decreasing the buoyancy of the hypothesis.

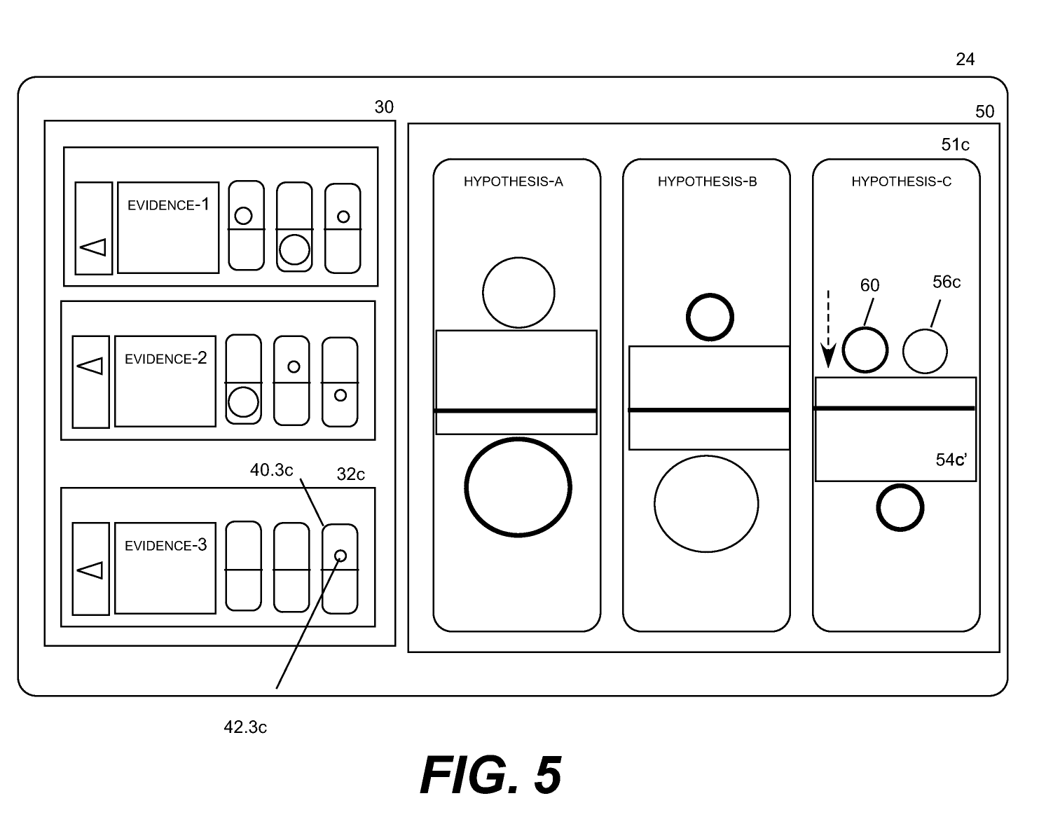

FIG. 5 illustrates adding another element of evidence as another option for changing the logical makeup of a hypothesis. Here, a new evidence bar 32c labeled “Evidence-3” has been added to the evidence panel 30. An instance of this piece of evidence has been added to hypothesis-C represented by the dynamic pictogram 51c above the hypothesis block 51c in the position of detracting evidence. This causes the hypothesis block to move downward from the position of the hypothesis block 54c shown in FIG. 2 to the position of the hypothesis block 54c′ shown in FIG. 5. Additional instances of this piece of evidence could be added to the other hypotheses, each with a different valence as desired. Further pieces of evidence may similarly be added with instances added to one or more of the hypotheses, as desired.

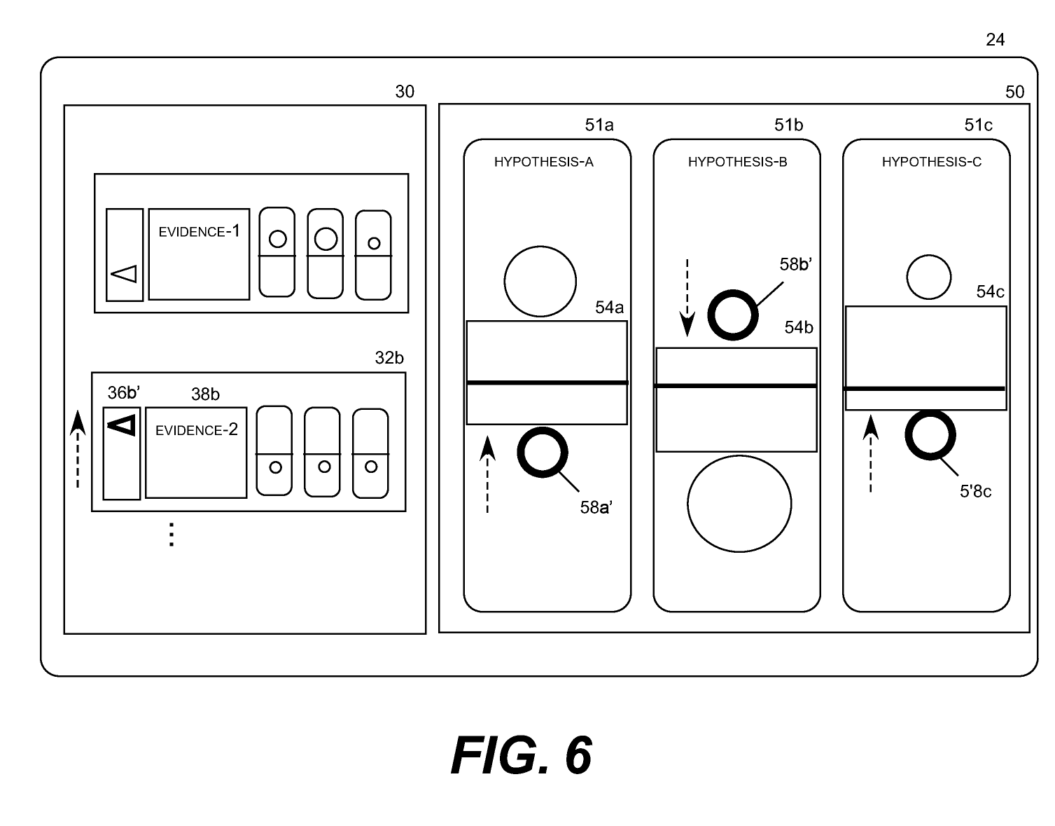

FIG. 6 shows a validity alteration, which is shown as a line weight adjustment but may be represented as a change in opacity, color or other visual attribute on a display screen. The evidence bar 32b serves as the example, in which the validity ascribed to this piece of evidence is increased by moving the slider 36b upward. This causes a common change to the validity values assigned to all instances of this evidence in the various hypotheses, which may have differing impacts on the various hypotheses depending on the valence and direction of the associated instances of the evidence. With respect to the initial validity values shown in FIG. 2, the increased validity value assigned in FIG. 6 as represented by increases in the line weights for the dynamic icon 58a′ in the hypothesis-A pictogram 51a, the dynamic icon 58b′ in the hypothesis-B pictogram 51b, and the dynamic icon 58c′ in the hypothesis-C pictogram 51c. For the supporting instances 58a′ and 58c′ (depicted as bubbles under their respective hypothesis blocks 54a and 54c), the increase in validity moves the hypothesis blocks 54a and 54a upward. Conversely, for the detracting instance 58b′ (depicted as a weight on top of the hypothesis block 54b), the increase in validity moves the hypothesis block 54b downward.

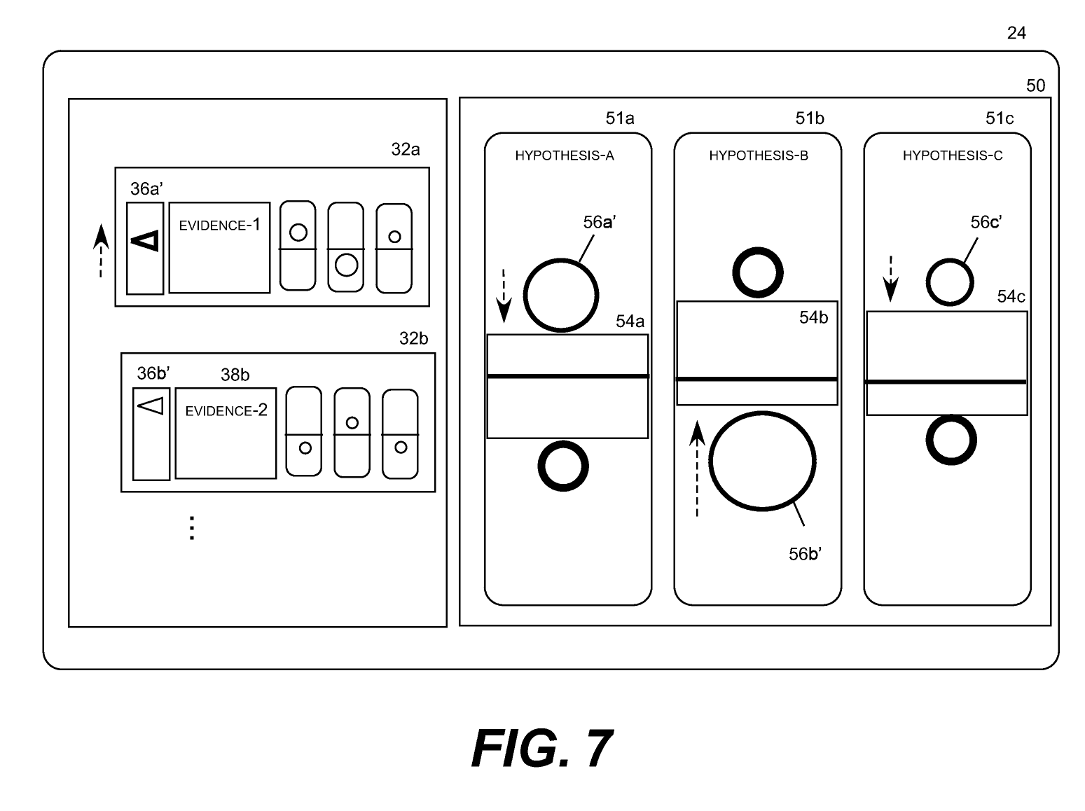

FIG. 7 shows a second validity alteration, in which the validity assigned to the first statement represented by the evidence bar 32a is increased. In this example, the valences of the instances (dynamic icons 56a-c) of this piece of evidence are different for the different hypotheses (dynamic pictograms 51a-c). As shown in FIG. 7, this validity change effects all of the dynamic icons 56a-c in a similar manner, while relative effect of the change on the computed validity of each hypothesis is different due to the differing valences. That is, for each dynamic icon 56a-c, the change in validity is weighted (multiplied) by the valence to obtain the overall change in the computed validity of the associated hypothesis. This is represented in FIG. 7 by the different sizes of the arrows and the different relative movements of the dynamic icon 56a-c caused by the validity change.

FIGS. 2-7 show the basic operations of the main display 24 of the logic visualization machine, in which competing hypotheses are represented in side-by-side dynamic physical analog pictograms and statements (evidence) can be added with instances (dynamic icons) assigned to one or more of the hypotheses. In addition, the valence of each instance of a statement (piece of evidence) can be altered on a per-hypothesis basis, while the validity can be altered on a per-statement basis which extends to all instances of that statement. The validity of each hypothesis is computed as the weighted sum of the supporting and detracting evidence assigned to the hypotheses, which is compactly visualized through the dynamic physical analog pictogram.

This functionality applies not only to an overall hypothesis, but also to every node in a logic tree structure. In other words, each dynamic icon in any dynamic pictogram may itself be a node representing a nested dynamic pictogram producing a computed validity for that particular node. The computed validity from any node can therefore be computationally and visually carried forward and combined with other pieces of evidence in a next-level node in a scalable hierarchical structure. The nested node structure therefore provides a computational basis for creating complex logic trees that culminate in computed validity assessments for top-level hypothesis. The resulting logic tree can be folded and unfolded as desired, with any selected node unfolded and visually displayed through the selected physical analog pictogram structure of the user interface 24 shown in FIG. 2 to reveal the underlying logical structure and components of the node.

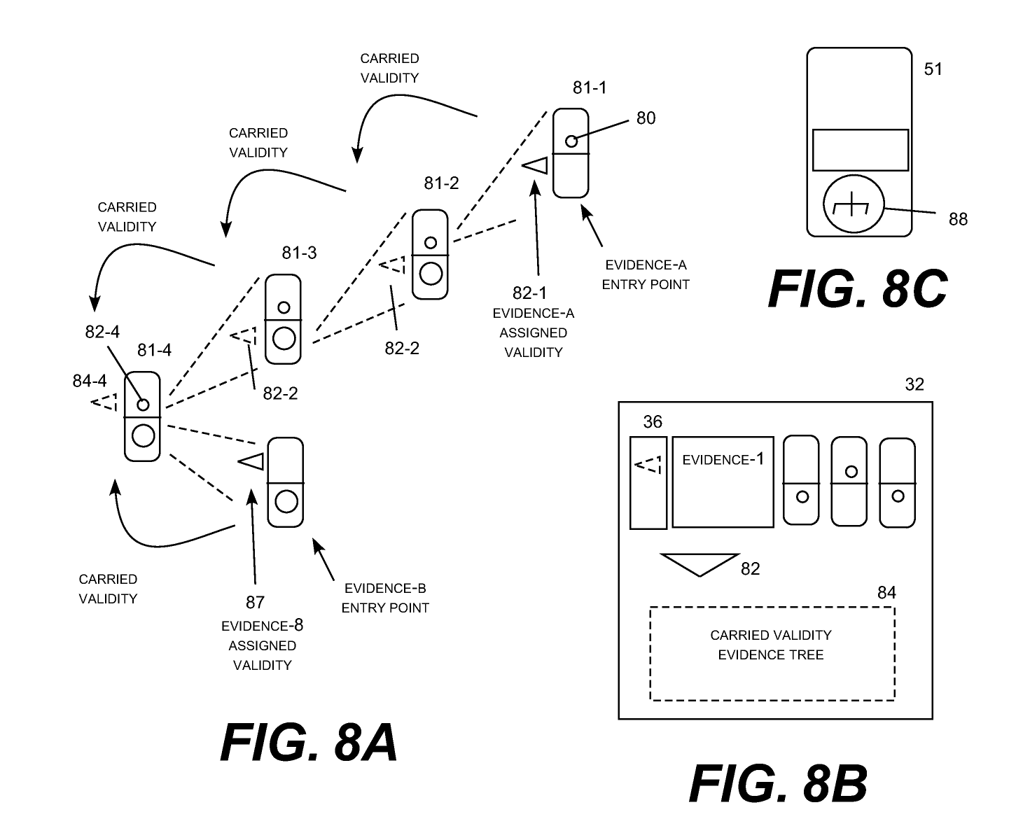

To accommodate sophisticated logical structures, the logic visualization machine is configured to handle several types of complex evidence including nested evidence, logical operation groups, and tag groups having some attribute in common. Evidence can also be sorted, filtered, and analyzed in a number of ways. FIG. 8A is a conceptual illustration of a nested evidence structure, which may be employed as a user interface technique for visualizing and handling nested evidence. FIG. 8A illustrates a nested node structure forming a logic tree, which is visualized as a series of nested test tubes (nodes), each representing a number of pieces of evidence. Each test tube (or other physical analog pictogram) effectively computes the weighted sum of the evidence considered by the node using the normalized valence and validity values assigned or computed for the various pieces of evidence. The result of the node is represented by an assigned or computed validity value, which can be carried forward to a subsequent node. It should therefore be appreciated that each node represents one or more pieces evidence, each of which may be a lower-level node representing one or more pieces of evidence, in a scalable hierarchical logic tree structure.

In many cases, the validity valuation of a node is a computed value based on the weighted sum of the components of the node. In some instances, however, the validity value is assigned by the user to a piece of original evidence at the entry point of that piece of evidence into the logic tree. Because the logic trees flow generally upward in a hierarchical structure, terminal nodes form the entry points for original evidence. The introduction of an original piece of evidence 80 into the logic tree is illustrated in FIG. 8A by the node 81-1. An original piece of evidence 80 is entered at the terminal node 81-1, where it is assigned a validity valuation 82-1 using the slider control. The assigned validity value is then carried forward into the subsequent node 81-2, where the original piece of evidence 80 may be combined with other pieces of evidence resulting in a computed validity valuation 82-2 for the subsequent node, which may be carried forward to another node 81-3 in the logic tree. This node 81-3 may also combine several pieces of evidence into a computed validity value 82-3, which is again carried forward to the node 81-4. The node 81-4 likewise combines several pieces of evidence to a computed validity value 82-4, and so forth.

FIG. 8B illustrates an evidence bar 32 displayed as part of an evidence panel 30 in the user interface 24. The evidence bar 32 represents a particular piece of evidence (one bubble or weight) in pictogram (test tube) representing a node in the logic tree. The evidence bar 32 is used to control a piece of nested evidence, such as the piece of evidence 82-4 shown as part of the node 81-4 in FIG. 8A. Since the evidence bar 32 represents a nested piece of evidence, it has a computed validity valuation and the validity slider control 36 shows the computed validity valuation but is inoperative (e.g., grayed out) since the validity valuation is not assigned at this point in the logic tree. The user may select an “expand view” selection item 82 to expose the nested evidence structure of the node, typically as a hierarchical list in a display box 84, as the physical analog diagram shown in FIG. 8A, or in any other suitable display format. This allows the user to readily track down the original sources of evidence incorporated into any node of the logic tree. For example, in FIG. 8A the user could track the evidence back to node 81-1, where the user can change the original validity value assigned to the evidence, if desired. FIG. 8C shows indicia 86 (network sign) displayed in connection with an dynamic icon for a nested piece of evidence indicating that it is a nested item and, therefore, not directly available for validity adjustment at the present node level.

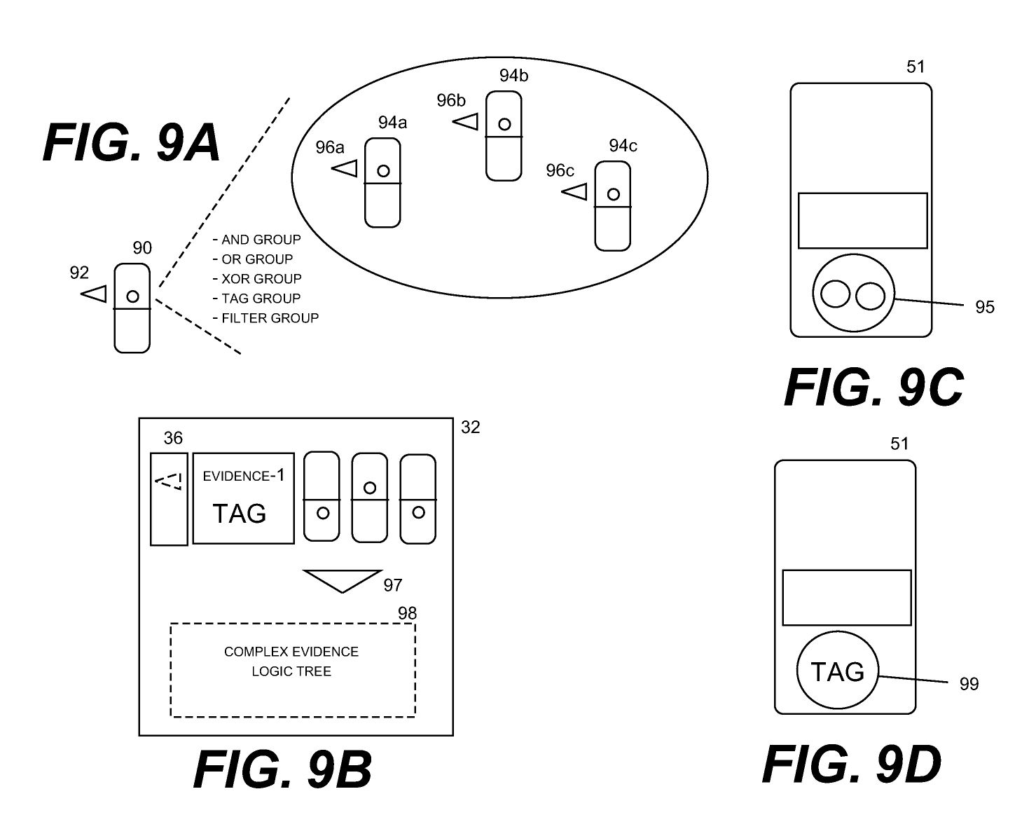

FIGS. 9A-C are conceptual illustrations of user interface techniques for visualizing logical operations evidence structures. Logic groups are additional types of complex evidence structures that may be folded into the nested tree structure illustrated in FIGS. 8A-C. That is, any piece of evidence (node) at any point in the hierarchical logic tree structure may represent a logic group which combines multiple pieces of evidence through a logical operation. This is illustrated in FIG. 9, in which a statement 90 has a computed validity value 92 which is computed though a logical operation applied to the group of statements 92a-c having computed or assigned validity values 96a-n. Examples of logical groups include AND, OR and XOR groups. For example, an AND group may be assigned the lowest validity value of the constituents, an OR group may be assigned the highest validity value of the constituents, and an XOR group may be assigned the value of one of the constituents only if all the other constituents validity values are null. While this example describes Boolean logic, other types of logical systems may be employed, which may be selected through user selection using the logic control item 46 in FIG. 2.

FIG. 9B illustrates an evidence bar 32, this time for a complex statement involving a logical operation. A logical operator control item 97 allows the user to expose and control the underlying logical structure of the statement, typically as a logical statement in a display box 98, as the physical analog diagram shown in FIG. 9A, or in any other suitable display format. At this point, the user may select, author, import or otherwise define any type of logical operation provided that the operation reduces to a normalized validity value that can be carried forward into the logic tree. FIG. 9C shows indicia 95 (internal bubbles in this example) that may be used to indicate that a dynamic icon represents a logical group.

In addition to evidence groups used for logical operations, the logic visualization machine allows the user to define classification groups for other purposes, such as consolidated review and coordinated validity adjustment. For example, FIG. 9D shows indicia 99 (TAG) used to indicate that a dynamic icon represents a classification group, in this case a tag group. Classification grouping may include tag groups (typically based on content), filter groups (typically based on metrics), and any other suitable classification. For example, a number of different tags may be applied to evidence indicating content, such as source, type, topic, methodology, security level, subject, or any other parameter the user elects to define as a tag group. The user interface allows the user to select a tag group, which exposes all of the statements under the selected tag on a common display. The user may also adjust the validity valuations for the entire tag group (or selected components of the group) with a consolidated control (e.g., discount all valuations from a certain source). Other types of evidence classifications may also be defined through filter groups using metrics such as date, assigned validity value, computed influence on a particular hypothesis, and so forth.

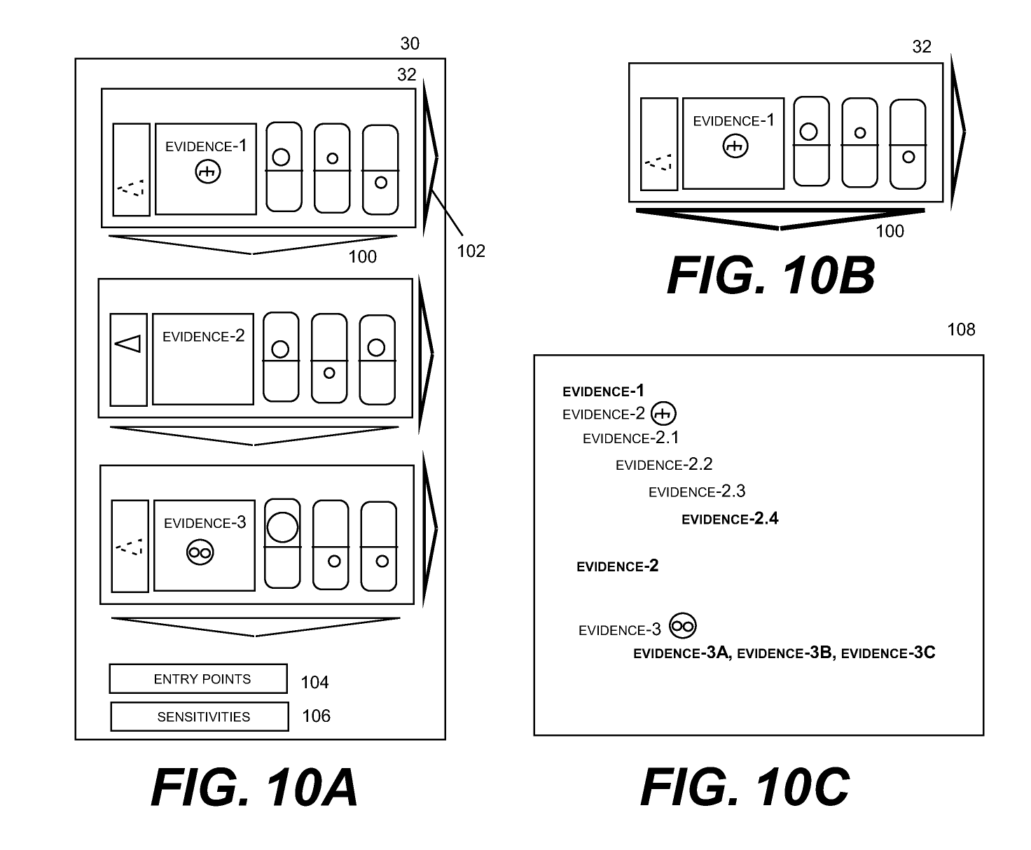

FIG. 10A-C are conceptual illustrations of user interface techniques for exposing evidence entry points and sensitivities in nested evidence structures. While many different user interface techniques of varying complexity may be utilized, simple techniques are used for the purpose of illustrating the underlying functionality. FIG. 10A shows the evidence panel 30 with two types of control items 100 and 102 for exposing evidence entry points and sensitivities. In this example convention, a downward pointing arrow 100 associated with an individual evidence bar 32 may be used to expose evidence entry points and a lateral pointing arrow 100 may be used to expose sensitivities on a per-statement basis. In addition, button control items 104 and 106 associated with the overall evidence panel 30 may be selected to expose the entry points for the logic tree on a global basis.

Selection of the “entry points” control arrow 100 as shown in FIG. 10B causes a pop-up list box to be displayed showing the evidence tree for this corresponding piece of evidence, while selecting the “entry points” control button 104 causes the list box to show all of the evidentiary entry points. FIG. 10B shows a list box 108 that may be displayed in response to selection of the “entry points” control button 104 to show the global set of evidence entry points. Here the terminal nodes represent the evidence entry points. The user may then select any entry point to access the evidence bar for the evidence entry point allowing the user the change the assigned validity value. Each terminal node may also serve as a hyperlink to a document expressing the evidence or other link associated with the source evidence.

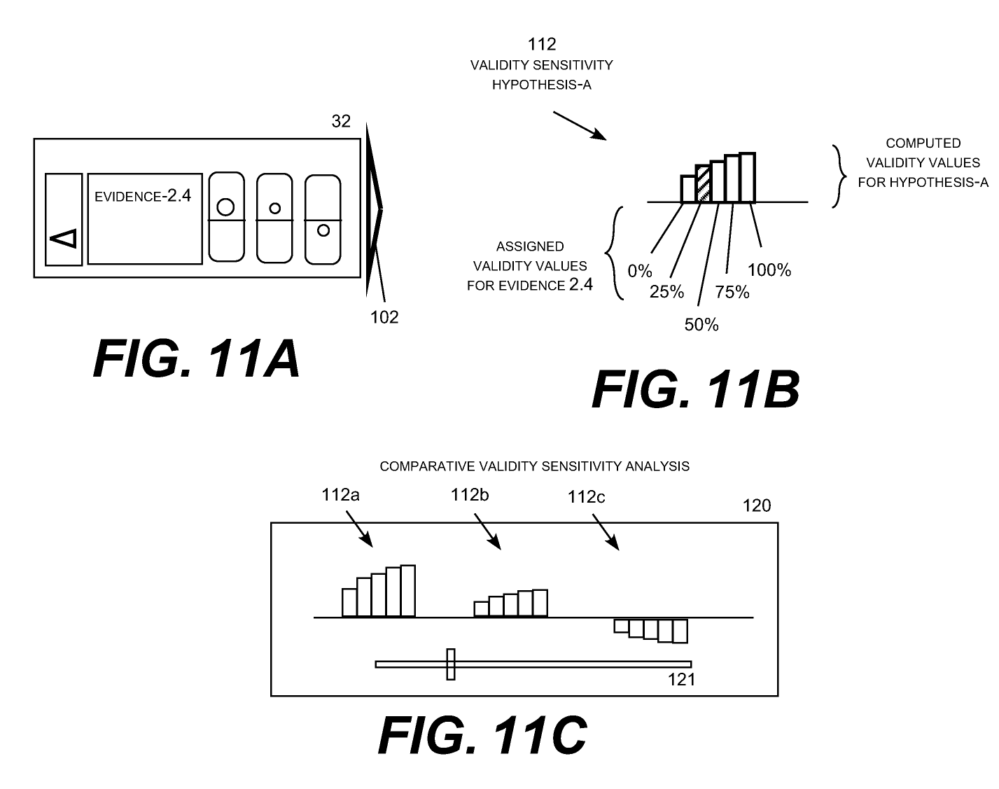

FIG. 11A-C are conceptual illustrations of user interface techniques for exposing sensitivities. FIG. 11B shows a sensitivity display 112 that may be exposed in response to selection of the sensitivity arrow control item 102 associated with the evidence bar 32 for a selected piece of evidence (evidence 2.4 in this example). The particular sensitivity display 112 is a bar graph in which each bar shows the computed validity for one of the hypotheses of the logic tree (e.g., hypotheses-A displayed through pictogram 51a in FIG. 2) with a different validity value selected for the corresponding piece of evidence (evidence 2.4). In this example, the left bar depicts the computed validity for hypotheses-A when the assigned validity value for evidence 2.4 is zero; the second bar from the left depicts the computed validity for hypotheses-A when the assigned validity value for evidence 2.4 is 25%; the center bar depicts the computed validity for hypotheses-A when the assigned validity value for evidence 2.4 is 50%; the second bar from the right depicts the computed validity for hypotheses-A when the assigned validity value for evidence 2.4 is 75%, and the right most bar depicts the computed validity for hypotheses-A when the assigned validity value for evidence 2.4 is 100%. As a result, the sensitivity display 112 shows the resulting computed validity for one of hypotheses (hypothesis-A in this example) with all parameters held constant except for one selected piece of evidence (evidence 2.4 in this example) in order to expose the sensitivity of the computed validity for that hypothesis (displayed as the height of the bar graph) to changes in the validity value assigned to the selected piece of evidence. As show in FIG. 11B, one of the bars in the graph may be highlighted to indicate the range of the current setting of the validity value assigned to the selected piece of evidence.

While FIG. 11B shows the sensitivity analysis for an example hypothesis, the logic visualization machine is conceptually capable of handling an unlimited number competing hypotheses and the typical user interface 24 shown in FIG. 2 is configured to show three competing hypotheses in side-by-side relation. FIG. 11C correspondingly shows a sensitivity panel 120 that includes three sensitivity displays 112a-c for the selected piece of evidence in side-by-side relation, one for each hypothesis. This provides the user to see the sensitivity of all three hypotheses to this particular piece of evidence at a glance on a common display. A scroll bar 121 may allow the user to peruse additional sensitivity displays if a greater number of hypotheses are enabled in the logic tree.

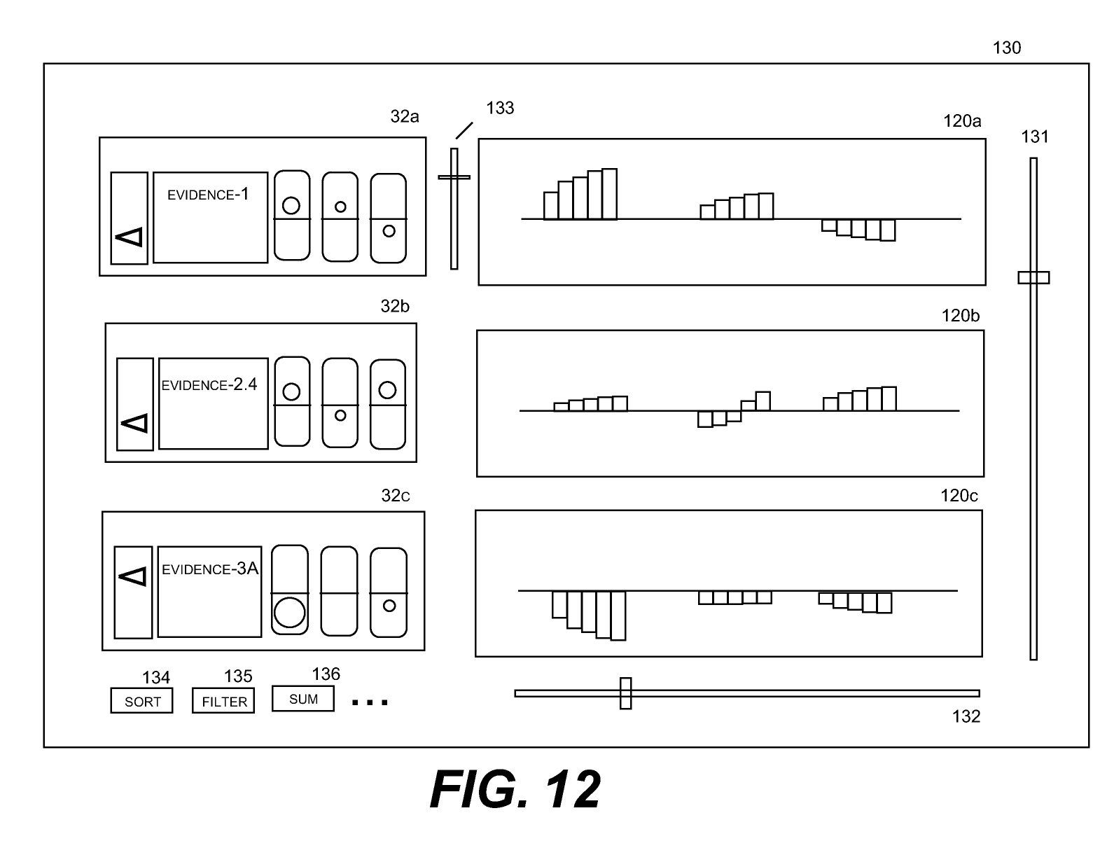

The user may also select the global “sensitivities” control button 106, which causes a source evidence panel 130 to display the evidence bars for all of the evidence entry points on the same display regardless of the node level of entry. The source evidence panel 130 is shown in FIG. 12, in which the sensitivity panels 120a-c are displayed alongside their corresponding entry-point evidence bars 32a-c. This allows the user to view and adjust the assigned validity values while viewing the sensitivities for all of the source evidence through a common display without having to navigate through node levels to get to the control points for different pieces of evidence. These user interface techniques for exposing hypothesis sensitivities in nested evidence structures greatly improve the power of the logic visualization machine as well as its ability to convey an intuitive “feel” for the underlying logic model to the users. Once a sophisticated logical structure has been constructed, the users have the ability to quickly identify and isolate the individual pieces of source evidence incorporated into the logical structure, ascertain the validity valuations assigned to the source evidence, and the sensitivity of overall results (i.e., the computed validity of hypotheses) to the validity valuations assigned to the original evidence. The ability to quickly expose sensitivities, alter the assigned validity valuations, and view the results in real time expressed through the highly intuitive interface environment provided by the physical analog pictogram, is a great advancement provided by the logic visualization machine over prior logic mapping systems. The presentation of a comparison of alternate hypotheses through a side-by-side visual comparison of physical analog pictograms further enhances the intuitive value of the logic visualization machine, which is compounded by the side-by-side visual comparison of sensitivities provided by source evidence panel 130 shown in FIG. 12.

FIG. 12 further illustrates additional control items for additional functionality applicable to source evidence. Note that FIG. 12 shows the items of source evidence at their entry points with their assigned validity displayed and enabled for adjustment on a common display. Vertical and horizontal scroll bars 131, 132 allow the user to readily access additional pieces of evidence (vertical scroll bar 131) and the sensitivities of additional hypotheses (horizontal scroll bar 132). The height of the sensitivity bars in the sensitivity panels 120a-c should be normalized across the evidence to present a view of the comparative weight of the evidence reflected in the end results represented by the computed validity values of the hypotheses (height of sensitivity bars). A normalization factor control item 133 may also be exposed to allow the scroll bars to be adjusted to a visually convenient height.

A fully developed sophisticated logic tree might include a great many pieces of evidence (scores, hundreds or even thousands) and quite a few competing hypotheses. The model is fully scalable and conceptually unlimited in this regard. The logic visualization machine therefore includes a range of evidence management feature activated by control buttons 134-136 in FIG. 12. Tagging the source evidence and other metrics recorded in metadata allow sorting, filtering and condensing (e.g., combining or summing) of evidence. For example, a sort control item 134 exposes a sorting interface that allows the user to sort the evidence according to various parameters, such as relative impact on the computed validity of the hypotheses, relative assigned validity value, origination date, entry date, modification date, and so forth. A filter control item 135 exposes a filter interface that allows the user to filter (select) the evidence shown in the source evidence panel 130 according to various parameters, such as subject matter, author, and so forth. Tags and other metrics included in evidence descriptions entered into the logic visualization machine or included in evidence source files directly or as metadata accessed by the machine typically serve as the sort and filter parameters. Another “sum” control item 136 allows the user to group evidence for common review or validity adjustment. For example, the validity values assigned to all evidence arising from a common source, or containing a common subject matter tag, or arising before a particular date, may be adjusted with a common command. These particular functions are merely illustrative, and many other features will become apparent to those using the logic visualization machine over time.

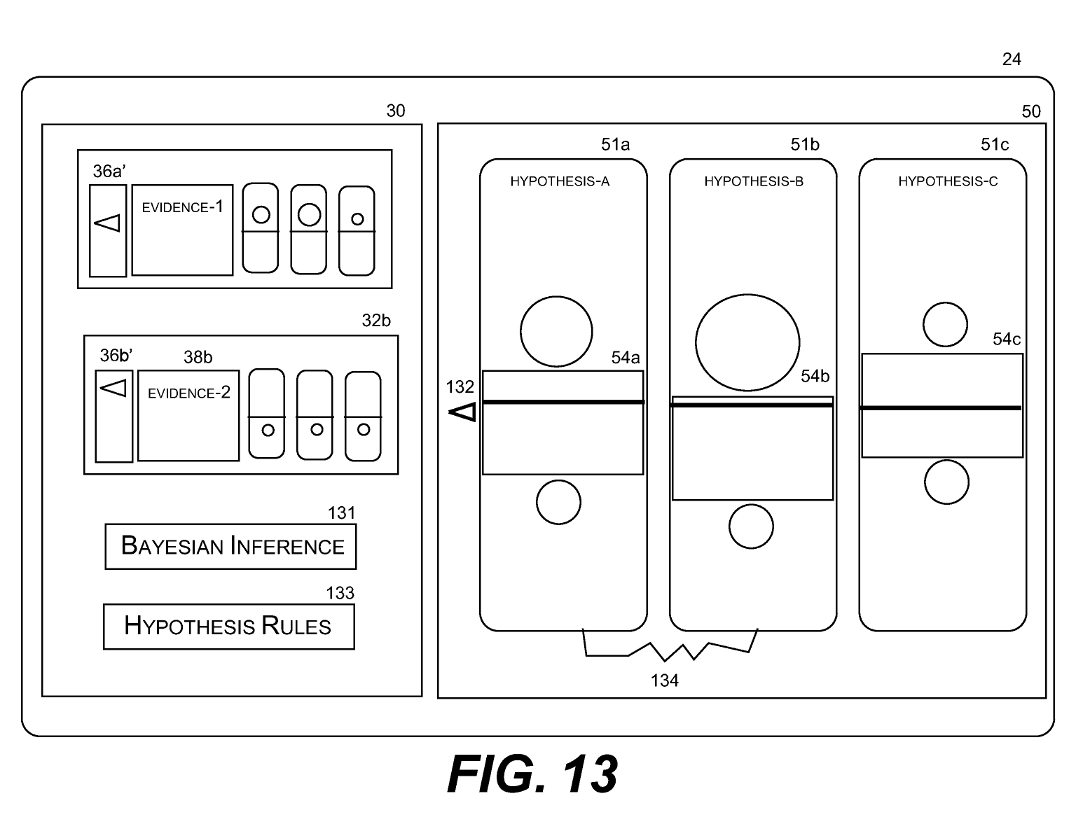

FIG. 13 is a conceptual illustration of a user interface technique for defining a Bayesian inference with the logic visualization machine. In most cases, a logic tree structure flows upward from assigned validity values entered at the terminal node entry points for the individual pieces of evidence toward the ultimate conclusions, which are represented as the computed validity valuations for ultimate hypotheses visualized through the physical analog pictogram selected by the user. A Bayesian inference, on the other hand, operates in the reverse direction where the user has the ability to assign the end result (hypothesis validity), which then propagates backwards through the logic tree to set the validity values for one or more individual pieces of evidence (i.e., those having a relaxes validity constraint for this purpose) to the values required to support the selected end result. It should be appreciated that the mathematical model of the logic visualization machine works in both directions. Once a logic map has been reduced to the computational structure of the machine, a Bayesian inference can be directly computed by fixing a desired end result (hypothesis validity) and relaxing the constraints on one or more validity valuations assigned to individual pieces of source evidence. The Bayesian inference effectively allocates an adjustment specified for a particular end result among a number of source pieces of evidence, typically by applying the necessary adjustment proportionately among the source items identified for constraint relaxation.

This Bayesian inference functionality is represented in FIG. 13 by the “Bayesian inference” control button 131 which, when selected, allows the user to set an ultimate result by setting the value of the validity slider 132 for a particular hypothesis. Selecting the “Bayesian inference” control button 131 also opens an interface that allows the user to relax the validity valuation constraints for selected items of original evidence, which are then computationally adjusted through the Bayesian inference logic to the values necessary to sustain the selected end result. It should be noted that the Bayesian inference adjustment defined by specifying the validity of one hypothesis will affect the validity valuations of the other hypotheses to the extent that they reflect the same evidence with adjusted validity value assignments.

The “Hypothesis Rules” button 133 shown in FIG. 13 illustrates another mechanism for establishing the ultimate validity value of a hypothesis where the probability is determined by a rule. The value of a hypothesis may also be constrained by one or more rule requiring multiple hypotheses to satisfy a logical statement, statistical correlation, fuzzy property, etc. entered or selected by the user. With this feature, conditions that alter the validity of one hypothesis may in turn affect validity of others. These validity constraints can be resolved either unidirectionally or simultaneously, as the validities seek an equilibrium that satisfies the rules. These constraints may be represented by dynamic pictograms, for example the spring 134 illustrates that two pictograms are tied together.

The present invention may be implemented as a software application running on a general purpose computer including an app for a portable computing device, a software application running on a server system providing access to a number of client systems over a network, or as a dedicated computing system. As such, embodiments of the invention may consist (but not required to consist) of adapting or reconfiguring presently existing equipment. Alternatively, original equipment may be provided embodying the invention.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “functionally connected” to each other to achieve the desired functionality. Specific examples of functional connection include but are not limited to physical connections and/or physically interacting components and/or wirelessly communicating and/or wirelessly interacting components and/or logically interacting and/or logically interacting components.

While particular aspects of the present subject matter have been shown and described in detail, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The invention is defined by the following claims, which should be construed to encompass one or more structures or function of one or more of the illustrative embodiments described above, equivalents and obvious variations.

The invention claimed is:

1. A non-transitory computer storage medium storing computer executable instructions for causing a logic visualization machine to perform a method comprising the steps of:
displaying a user interface for creating, visualizing and modifying a logical argument and interacting with a user through the user interface to create a computer model the logical argument;
depicting a hypothesis of the logical argument as a dynamic physical analog pictogram in which a computed validity of the hypothesis is represented by a visual aspect of the pictogram having physical significance within the physical analog of the pictogram;
depicting an item of evidence as a dynamic icon within the pictogram having physical significance within the physical analog of the pictogram;
assigning a valence value to the dynamic icon defining a magnitude of influence that the item of evidence has on the hypothesis and depicting the valence value as a visual aspect of the dynamic icon having physical significance within the physical analog of the pictogram;
assigning a direction to the dynamic icon defining whether the influence is supporting or detracting the computed validity of the hypothesis and depicting the direction as a visual aspect of the dynamic icon having physical significance within the physical analog of the pictogram;
assigning or computing a validity value for the dynamic icon defining a confidence in validity of the item of evidence and depicting the validity value as a visual aspect of the dynamic icon having physical significance within the physical analog of the pictogram;
computing a validity effect of the item of evidence on the computed validity of the hypothesis based on the valence value, direction, and validity value of the item of evidence and depicting the validity effect as a change to the visual aspect of the pictogram representing the computed validity of the hypothesis.

2. The computer storage medium of claim 1, wherein the hypothesis is a first hypothesis and the pictogram is a first pictogram, further comprising the steps of:
depicting a second hypothesis of the logical argument as a second dynamic physical analog pictogram; and
displaying the first and second hypotheses in side-by-side relation.

3. The computer storage medium of claim 1, wherein:
the valence value is normalized;
the validity is a normalized;
the direction is positive or negative unity; and
the validity effect of the item of evidence is computed as the product of the valence value, the validity value, and the direction.

4. The computer storage medium of claim 1, wherein:
the pictogram comprises a test tube;
the computed validity of the hypothesis is depicted as a floatation level of an evidence block floating within the test tube;
supporting evidence is depicted as a bubble under the evidence block having a physical analog significance of increasing the floatation level; and
detracting evidence is depicted as a ballast on top of the evidence block having a physical analog significance of decreasing the floatation level.

5. The computer storage medium of claim 1, further comprising the steps of:
adjusting the valence value assigned to the dynamic icon and changing the visual aspect of the pictogram representing the computed validity of the hypothesis based on the adjusted valence value;
adjusting the direction assigned to the dynamic icon and changing the visual aspect of the pictogram representing the computed validity of the hypothesis based on the adjusted direction; and
adjusting the validity value assigned to the dynamic icon and changing the visual aspect of the pictogram representing the computed validity of the hypothesis based on the adjusted validity value.

6. A non-transitory computer storage medium storing computer executable instructions for causing a logic visualization machine to perform a method comprising the steps of:
displaying a hypothesis panel comprising a plurality of dynamic physical analog pictograms displayed in side-by-side relation, wherein each pictogram represents an alternative hypothesis of a logical argument;
displaying an evidence panel comprising a plurality of evidence bars that each represent an item of evidence, wherein each item of evidence represents an evidentiary component assignable to the hypotheses of the logical argument;
assigning an instance of each item evidence to one or more of the hypotheses, wherein each instance includes a hypothesis-specific valence value, a hypothesis-specific direction, and a global validity valuation applied to all instances;
computing a validity value for each hypothesis determined as a weighted sum of the valence values of the items of evidence assigned to the hypothesis, wherein the validity values are utilized as weighting factors, and wherein the directions are utilized as positive or negative unity; and
displaying the computed validity values and dynamic icons as visual aspects of the pictograms having physical significance within the physical analog of the pictograms.

7. The computer storage medium of claim 7, wherein:
the pictogram comprises a test tube;
the computed validity of the hypothesis is depicted as a floatation level of an evidence block floating within the test tube;
an item of supporting evidence is depicted as a bubble under the evidence block having a physical analog significance of increasing the floatation level; and
an item of detracting evidence is depicted as a ballast weight on top of the evidence block having a physical analog significance of decreasing the floatation level.

8. The computer storage medium of claim 6, further comprising the steps of:
configuring one or more of the items of evidence as a complex item of evidence incorporating multiple evidentiary components.

9. The computer storage medium of claim 8, wherein the complex item of evidence represents a node in a hierarchical logical tree structure.

10. The computer storage medium of claim 9, wherein the complex item of evidence represents a logical operation applied to a logical group of items of evidence.

11. The computer storage medium of claim 9, wherein the complex item of evidence represents a common operation applied to an aggregated group of items of evidence.

12. The computer storage medium of claim 11, wherein the aggregated group comprises a tag group having subject matter or a property in common.

13. The computer storage medium of claim 11, wherein the aggregated group comprises a filter group having a sort metric in common.

14. A non-transitory computer storage medium storing computer executable instructions for causing a logic visualization machine to perform a method comprising the steps of:
creating a logical argument in a hierarchical logic tree structure comprising nested nodes;
representing a hypothesis for each node by a dynamic physical analog pictogram in which one or more pictograms of other nodes are incorporated as evidentiary components of the pictogram;
assigning validity values to evidentiary components representing items of source evidence at their points of entry into the logic tree structure;
assigning valence values and directions to each evidentiary component;
computing a validity value for each pictogram determined as a weighted sum of the valence values of the evidentiary components assigned to the node, wherein the validity values are utilized as weighting factors, and wherein the directions are utilized as positive or negative unity; and
for any selected node, displaying the computed validity value of the associated hypothesis and the evidentiary components of the node as visual aspects of the pictogram having physical significance within the physical analog of the pictogram.

15. The computer storage medium of claim 14, wherein:
the pictogram comprises a test tube;
the computed validity of the hypothesis is depicted as a floatation level of an evidence block floating within the test tube;
supporting evidentiary components are depicted as bubbles under the evidence block having a physical analog significance of increasing the floatation level; and
detracting evidentiary components are depicted as ballast weights on top of the evidence block having a physical analog significance of decreasing the floatation level.

16. The computer storage medium of claim 14, further comprising the step of displaying an unfolded tree structure to identify entry points of source evidence at terminal nodes of the tree structure.

17. The computer storage medium of claim 14, further comprising the steps of:
receiving adjustments to the validity values assigned to one or more of the items of source evidence; and
displaying indications of the adjustments to the validity values assigned to the items of source evidence and corresponding changes to a computed validity value for the hypothesis resulting from those adjustments to the validity values assigned to the items of source evidence on a common user interface display.

18. The computer storage medium of claim 14, further comprising the step of computing and displaying a sensitivity analysis illustrating a range of adjustments to the validity value assigned to an item of source evidence and corresponding changes to a computed validity value for the hypothesis resulting from those adjustments to the validity value assigned to the item of source evidence.

19. The computer storage medium of claim 18, further comprising the step of computing and displaying a sensitivity panel for the item of source evidence, wherein the sensitivity panel includes multiple sensitivity analyses, and wherein each sensitivity analysis corresponds to a different hypothesis.

20. The computer storage medium of claim 19, further comprising the step of computing and displaying multiple sensitivity panels on a common user interface display, wherein each sensitivity panel corresponds to a different item of source evidence, wherein each sensitivity panel includes multiple sensitivity analyses, and wherein each sensitivity analysis corresponds to a different hypothesis.
